(19) United States
(12) Patent Application Publication
(10) Pub. No.: US 2001/0023399 A1
(43) Pub. Date: Sep. 20, 2001

(54) Audio signal processing apparatus and signal processing method of the same

(76) Inventors: Jun Matsumoto, Kanagawa (JP); Masayuki Nishiguchi, Kanagawa (JP)

Correspondence Address: Jay H. Maioli, Cooper & Dunham LLP, 1185 Avenue of the Americas, New York, NY, 10036, US

(21) Appl. No.: 09/801,285

(22) Filed: Mar. 7, 2001

(30) Foreign Application Priority Data
Mar. 9, 2000 (JP) P2000-071081

(51) Int. Cl. G10L 13/04; G10L 13/02

(52) U.S. Cl. 704/262

(57) ABSTRACT

An audio signal processing apparatus and method using pitch information to change a length of predictive residual signals while maintaining continuity and thereby enabling conversion of a reproduction speed without changing a pitch and enabling a conversion of speed by a small amount of calculation, comprising shortening or extending residual signals on a time axis while maintaining pitch information, cutting out signals and connecting of different pitch sections in the respective frames based on resemblance of signals at the time of shortening, and extending predictive residual signals in respective frames by extrapolation at the time of extension. An audio signal compressed or expanded on the time axis can be reproduced without changing the pitch by synthesizing an audio signal by an LPC synthesis filter based on the generated new predictive residual signals.

### BACKGROUND OF THE INVENTION

1. Field of the Invention

The present invention relates to an audio signal processing apparatus and a signal processing method capable of changing a reproduction speed of an audio signal without changing a pitch and capable of easily realizing a change of the reproduction speed by a small amount of calculations.

2. Description of the Related Art

In order to convert the reproduction speed of an audio signal (including a voice signal and a sound signal, hereinafter, simply referred to as an audio signal) without changing the pitch, it is necessary to perform a wide range of cross-correlation calculations on the audio signal. Further, it is necessary to calculate in advance a framework for enabling flexible parameter interpolation of the audio signal, that is, a parametric expression of an audio signal.

As a decoder for audio encoding performing forward prediction, there is a code excited linear prediction (CELP) decoder. FIG. 7 is a block diagram of an example of the configuration of a CELP decoder. As shown in the figure, the CELP decoder comprises an adaptive code book 10, a gain code book 20, a stochastic code book 30, buffers 40 and 50, an adder circuit 60, and a linear prediction code (LPC) synthesis filter 70.

In a CELP decoder, residual signals e(n) are obtained by adding signals adjusted in amplitude of a pitch component eₐ(n) and a noise component eₛ(n). In accordance with the residual signals e(n), an audio signal S(n) is synthesized by the LPC synthesis filter 70.

Summarizing the disadvantage to be solved by the invention, in the CELP or other decoder for forward prediction encoding of the related art, there is a disadvantage that the conversion of the audio signal on the time axis requires a large amount of computations and difficult processing.

### SUMMARY OF THE INVENTION

An object of the present invention is to provide an audio signal processing apparatus and a signal processing method capable of changing a reproduction speed of an audio signal without changing its pitch and capable of changing a reproduction speed of an audio signal by a small amount of calculations by utilizing the pitch information of the audio signal and changing a length of predictive residual signals while maintaining continuity.

To attain the above object, according to a first aspect of the present invention, there is an audio signal processing apparatus for reproducing an audio signal based on predictive residual signals in decoding of a signal encoded by forward prediction on a frame by frame basis, comprising an excitation source modifying means for extending or shortening the predictive residual signals on a time axis and a synthesizing means for synthesizing an audio signal based on predictive residual signals converted by the excitation source modifying means.

According to a second aspect of the present invention, there is provided an audio signal processing apparatus for reproducing an audio signal based on predictive residual signals in decoding of a signal encoded by forward prediction on a frame by frame basis, comprising an excitation source modifying means for shortening the predictive residual signals by taking out first signal from one sub-frame of the predictive residual signals and second signal from signal in a following sub-frame or for extending the predictive residual signals by connecting data estimated by extrapolation to signals of a frame while maintaining the pitch and a synthesizing means for synthesizing an audio signal based on predictive residual signals converted by the excitation source modifying means.

Preferably, the excitation source modifying means comprises dividing means for dividing signal of a sub-frame into first signal whose length is m (m is integer and m<L, L is the length of said sub-frame) and the remaining signal whose length is (L−m) as a reference signal and finding means for finding the closest signal of said reference signal from a signal of other sub-frame and shortens said predictive residual signals by concatenating the first signal and the closest signal.

Preferably, the excitation source modifying means comprises a first multiplying means for multiplying the reference signal by a first window function; a second multiplying means for multiplying signal taken out from the other sub-frame by a second window function; and an adding means for adding results of the first and second multiplying means; and concatenates the results of the adding means after the first signal taken out from said sub-frame to generate one pitch worth of new predictive residual signals.

Preferably, the finding means calculates cross-correlation values with the reference signal for signal of the other sub-frame, cuts out a signal from a position where the calculated cross-correlation value becomes the largest as the closest signal.

Alternatively, the finding means calculates a square error with the reference signal for signal of the other sub-frame, cuts out a signal from a position where the calculated square error becomes the smallest as the closest signal.

Preferably, the excitation source modifying means extends the predictive residual signals by a certain extension rate by finding a signal having a predetermined length from the end of the predictive residual signals of a frame and concatenating said signal after the end of the predictive residual signal to generates new residual signals.

Preferably, the synthesizing means is a linear prediction code synthesis filter.

According to a third aspect of the present invention, there is provided an audio signal processing method for extending or shortening predictive residual signals on a time axis in decoding of a signal encoded by forward prediction on a frame by frame basis, comprising processing for shortening the predictive residual signals by cutting out first signal from signal in a sub-frame of the predictive residual signals and second signal from signal in a following sub-frame based on cross-correlation while maintaining the pitch or for extending the predictive residual signals by connecting data estimated by extrapolation to signals of a frame so as to shorten or extend the signals of one frame and processing for synthesizing an audio signal based on such shortened or extended predictive residual signals.

Preferably, the method further comprises shortening the predictive residual signals by cutting out from the predictive residual signals input for every frame m number of signals (m is an integer and m<L) out of a length L of one pitch from predictive residual signals in a previous frame, using the remaining signals (L−m) as reference signals to cut out the closest signals to the reference signals from the predictive residual signals in the next frame, and connecting them after the m number of signals taken out from the previous frame to generate one pitch worth of new predictive residual signals, dividing a signal of said sub-frame into the first signal whose length is m (m is an integer and m<L, L is the length of said sub-frame) and the remaining signal whose length is (L−m) as a reference signal, finding the closest signal of said reference signal from the other sub-frame and concatenating the first signal and the closest signal.

Preferably, the method further comprises shortening the predictive residual signals by first multiplication processing for multiplying the reference signal by a first window function; second multiplication processing for multiplying cut-out signal from the other sub-frame by a second window function; and adding processing for adding results of the first and second multiplying means and connecting the results of the adding processing after the first signal cut out from said sub-frame to generate one pitch worth of new predictive residual signals.

Preferably, the method further comprises extending the predictive residual signals by a certain extension rate by finding a signal having a predetermined length from the end of the predictive residual signals of a frame and concatenating said signal the end of the predictive residual signals to generates extended predictive residual signals.

### BRIEF DESCRIPTION OF THE DRAWINGS

These and other objects and features of the present invention will become more clearer from the following description of the preferred embodiments given with reference to the attached drawings, in which:

FIG. 1 is a circuit diagram of an embodiment of audio signal processing according to the present invention;

FIGS. 2A and 2B are waveform diagrams showing processing when shortening a residual signal e(n) on a time axis;

FIG. 3 is a waveform diagram showing processing for extending data by extrapolation;

FIGS. 4A to 4D are waveform diagrams showing processing for improving data continuity of residual signals to be connected by using a window function;

FIG. 5 is a waveform diagram of processing for extending a residual signal e(n) on a time axis by extrapolation;

FIGS. 6A and 6B are waveform diagrams of a method for improving continuity of data when extending a residual signal by using a window function; and

FIG. 7 is a block diagram of an example of a CELP encoded audio signal decoder of the related art.

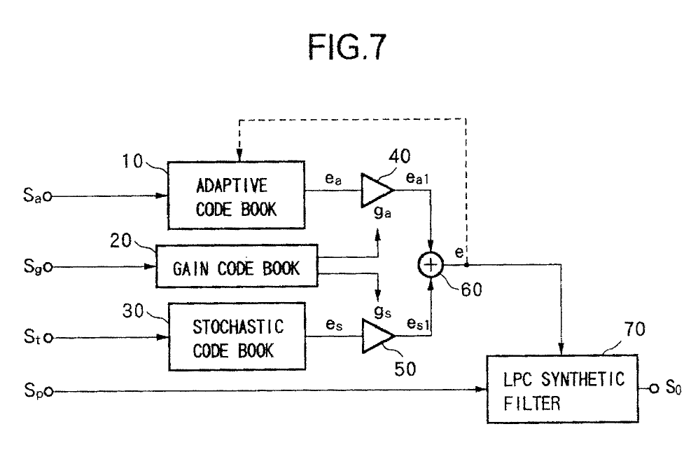

### DESCRIPTION OF THE PREFERRED EMBODIMENTS

First Embodiment

To convert a reproduction speed of an audio signal without changing its pitch, there are the method of signal processing on a time axis, for example, the processing method called PICOLA, and the method of changing a method of interpolation of parameters on a frequency axis. The present invention proposes a method of signal processing by signal processing on the time axis, particularly in a residual signal region, not an audio signal region, and a signal processing apparatus for realizing the method.

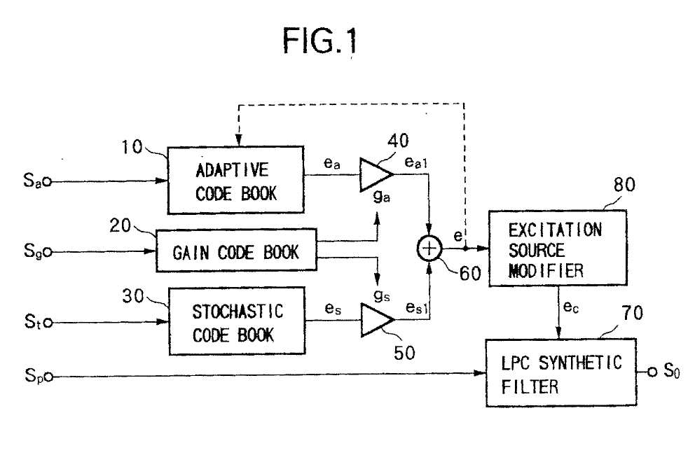

FIG. 1 is a circuit diagram of an embodiment of a signal processing apparatus according to the present invention.

As shown in the figure, a signal processing apparatus of the present embodiment comprises an adaptive code book 10, a gain code book 20, a stochastic code book 30, buffers 40 and 50, an adder circuit 60, a linear prediction code (LPC) synthesis filter 70, and an excitation source modifier 80.

As shown in the figure, an audio signal processing apparatus of the present invention is applied to a code excited linear prediction (CELP) decoder. This is a normal CELP decoder plus the excitation source modifier 80.

In the audio signal processing apparatus of the present invention, the excitation source modifier 80 cuts out data or uses extrapolation to shorten or extend the data on the time axis in accordance with a residual signal e(n) calculated in accordance with a pitch component eₐ(n) and a noise component eₛ(n) in the CELP decoder, whereby it becomes possible to change the length of the audio signal on the time axis and convert the reproduction speed of the audio signal without changing the pitch component.

In the audio signal processing apparatus of the present invention, the adaptive code book 10 calculates a signal eₐ(n) indicating a present pitch component (hereinafter, simply referred to as a pitch component for convenience) in accordance with an index Sₐ of an input pitch component and outputs the same to the buffer 40. Note that, as shown in FIG. 1, the residual signal e(n) calculated by the adder circuit 60 is fed-back to the adaptive code book 10. Namely, the adaptive code book 10 is updated in accordance with the fed-back residual signal e(n) in the same way as in a normal decoder.

The stochastic code book 30 calculates a signal eₛ(n) indicating a present noise component (hereinafter simply referred to as a noise component for convenience) in accordance with an index Sₚ of an input noise component and outputs the same to the buffer 50.

The gain code book 20 calculates a pitch component gain control signal gₐ and a noise component gain control signal gₛ in accordance with an index S_{g} of an input gain and outputs them to the buffers 40 and 50, respectively.

The buffer 40 controls an amplitude of the pitch component eₐ(n) by a gain set by the pitch component gain control signal gₐ and supplies a pitch component eₐ₁(n) to the adder circuit 60.

The buffer 50 controls an amplitude of the noise component eₛ(n) by a gain set by the noise component gain control signal gₛ and supplies a noise component eₛ₁(n) to the adder circuit 60.

Namely, the pitch component eₐ(n) and the noise component eₛ(n) are controlled in their amplitudes by the pitch component gain control signal gₐ and the noise component gain control signal gₛ obtained from the gain code book 20. The obtained pitch component eₐ₁(n) and noise component eₛ₁(n) are sent to the adder circuit 60.

By adding the pitch component eₐ₁(n) and the noise component eₛ₁(n) in the adder circuit 60, a residual signal e(n) is calculated and output to the excitation source modifier 80.

The excitation source modifier 80 performs processing for shortening and extending the residual signal e(n) on the time axis by cutting or extrapolation or other interpolation. Due to this, a residual signal e_{c}(n) converted in length on the time axis is obtained without changing the pitch. The residual signal e_{c}(n) obtained by the excitation source modifier 80 is output as a drive sound source to the LPC synthesis filter 70, whereby the audio signal S₀(n) is reproduced.

The LPC synthesis filter 70 synthesizes and reproduces the audio signal in accordance with the residual signal e_{c}(n) output by the excitation source modifier 80 and an LPC coefficient Sₚ input from the outside. Since the residual signal extended or shortened on the time axis is supplied by the excitation source modifier 80, the audio signal S₀(n) synthesized by LPC synthetic filter 70 becomes an audio reproduction signal which is extended or shortened on the time axis without the pitch being changed compared with the original audio signal.

In the present invention, the above adaptive code book 10, gain code book 20, stochastic code book 30, and LPC synthesis filter 70 are the same as those of the CELP decoder of the related art. The excitation source modifier 80 of the present invention shortens and extends the residual signal e(n) on the time axis by cutting or extrapolation or other interpolation.

Below, the operation of the excitation source modifier 80 will be explained in further detail to further clarify the principle and method of processing for conversion of the reproduction speed of an audio signal in the present invention.

The excitation source modifier 80 performs processing to extend or shorten a residual signal e(n) on the time axis. Below, the shortening a residual signal e(n), that is, raising a reproduction speed of an audio signal, will be explained by using examples of signal waveforms.

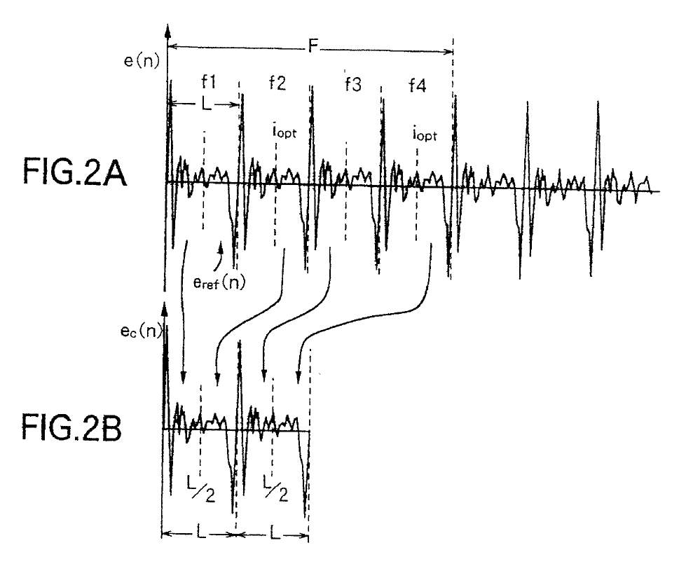

FIGS. 2A and 2B are waveform diagrams showing the principle of shortening a residual signal e(n) in the excitation source modifier 80. FIG. 2A is a view of an example of a waveform of a residual signal e(n). Here, it is assumed that the residual signal e(n) is a signal digitized by a predetermined sampling frequency in the audio signal processing apparatus. The sampling frequency fₛ is, for example, 8 kHz. In linear prediction coding (LPC) of an audio signal, the audio signal is processed in units of frames divided on the time axis. For example, when one frame has a length of 20 ms and sampling is performed at 8 kHz, data of 160 samples can be obtained in one frame. Further, in the processing in the excitation source modifier 80 of the present invention, each frame is divided to four sub-frames. Each sub-frame has data of 40 samples and a length of 5 ms on the time axis.

Below, the shortening (cutting) of the residual signal e(n) shown in FIG. 2A will be explained under the above conditions. Here, the explanation will be made taking as an example the processing for compressing the residual signal e(n) to half of its original length on the time axis, that is, for doubling the reproduction speed.

In a CELP decoder, the pitch of the audio signal is found by forward prediction of the audio signal. Namely, when cutting in the excitation source modifier 80, the pitch is already known.

Here, the residual signal between frames F is designated as e(n) (n=0, 1, 2, . . . , 159). The length of the pitch of the audio signal is L. The pitch L is already known in the frame F. Here, it is assumed that L=40. The frame F is further divided to four sub-frames f1, f2, f3, and f4.

To double the reproduction speed of the audio signal means to find a new residual signal e_{c}(n) having an unchanged pitch L and half the length of the original residual signal on the time axis based on the residual signal e(n). To realize this, the excitation source modifier 80 of the present embodiment takes out half of the data from one pitch worth of data, uses the remaining half data as a reference signal to search for the signal closest to the reference signal from the next one pitch worth of data in the original residual signal, and combines the found data and the data taken out from the previous pitch to generate one pitch worth of new residual data. As a result of such processing, a new audio signal doubled in reproduction speed without changing the pitch of the original audio signal and maintaining the characteristics of the original audio signal can be reproduced. Note that as the method for gauging the degree of approximation with the reference signal, it is possible to make a judgement based on a cross-correlation value or a square error value. Namely, the signal closest to the reference signal can be found by the judgement criteria of the largest cross-correlation value with the reference signal or the smallest square error with the reference signal. Here, as an example, the square difference (or average square error) with the reference signal is used as the standard and the signal having the least square error is made the signal closest to the reference signal. Below, the method of audio signal processing of the present embodiment will be explained in further detail by taking as an example the waveform of a residual signal shown in FIG. 2A.

First, in the first sub-frame f1, data having half the length of the pitch L is taken out from an appropriate position of the residual signals e(0) to e(39) to obtain converted residual signals e_{c}(0) to e_{c}(19). Note that the cutting position can be set around the position where a peak of the residual signals e(n) appears in the first sub-frame f1. As a result, a first half of one pitch worth of new residual signals e_{c}(n) is formed.

Next, the second half of the one pitch worth of new residual signals e_{c}(n), that is, the residual signals e_{c}(20) to e_{c}(39), are obtained. Note that to compress the length of an audio signal and to sufficiently maintain the characteristics of the original audio signal, the second half of the one pitch worth of the residual signals e_{c}(n) has to be obtained from the next sub-frame f2. Here, using the left over second half of the one pitch worth of the residual signals in the sub-frame f1, that is, the residual signals e(20) to e(39), as reference signals e_{ref}(n), portions giving the smallest square error E(i) with respect to the reference signals e_{ref}(n) are found from the sub-frame f2. This code series is used for the second half of the one pitch worth of the new residual signals e_{c}(n), that is, the residual signals e_{c}(20) to e_{c}(39). The square error E(i) is obtained by the following calculation.

$$E ( i ) = {\sum }_{n = 0}^{L / 2 - 1} {( {e}_{ref} ( n ) - z ( n + i ) )}^{2} \qquad ( 1 )$$

In equation (1), e_{ref}(n)=e (n+20) and x(n)=e(n+40) (n=0, 1, 2, . . . , 19). In accordance with equation (1), an error E of each i is obtained, and a value iₒₚₜ by which E(i) becomes the smallest is obtained. Namely, iₒₚₜ is obtained by the next equation.

$$\begin{matrix}{i}_{opt} = arg min E ( i ) \\ = arg min {\sum }_{n = 0}^{L / 2 - i} ( {{e}_{ref} ( n9 - x ( n + i ) )}^{2}\end{matrix} \qquad ( 2 )$$

In equation (2), “argmin” is an operator indicating a value of i when the latter equation gives the smallest value.

By the calculated iₒₚₜ, 20 pieces of data are cut out from the iₒₚₜ-th data from the top of the sub-frame f2 to make new residual signals e_{c}(20) to e_{c}(39). Namely, using the signals e(n) of the latter half of the sub-frame f1 as reference signals e_{ref}(n), the signals closest to the reference signals e_{ref}(n) are found from the sub-frame f2 and joined to the second half of the one pitch worth of the new residual signals e_{c}(n) generated.

Here, for example, it is assumed iₒₚₜ=15 as a result of the calculation based on equation (2). Therefore, 20 continuous pieces of data are taken out from the 15th residual signal data in the sub-frame f2 and used for the second half of the one p itch worth of the new residual signals e_{c}(n). Namely, data e_{c}(20) to e_{c}(39) are comprised of e(35) to e(54), respectively.

From the above processing, one pitch worth of data of the new residual signals, that is, the residual signals e_{c}(0) to e_{c}(39), is obtained. FIG. 2B is a waveform diagram of the thus calculated residual signals e_{c}(n).

Next, the second pitch worth of the residual signals e_{c}(n) (n=41, 42, . . . , 79) are obtained. First, half of a pitch worth of the residual signals e(n) are taken out from an appropriate portion, for example, a peak position or its surroundings, of the residual signals e(n), to obtain a first half of the second pitch worth of the new residual signals e_{c}(n).

Using the residual signals corresponding to half of the one pitch worth of data from the tail end of the data taken out in the residual signals e(n) as reference signals e_{ref}(n), the data closest to the reference signals e_{ref}(n) are searched for from the fourth sub-frame f4 of the original residual signals e(n). Then, as explained above, a square error of the reference signals and the residual signals is obtained as shown in equation (1) as a criteria for measuring a degree of approximation with the reference signals. Assuming a position where the square error becomes the smallest to be iₒₚₜ, half a pitch worth of data are taken out from the iₒₚₜ and used as the second half of the one pitch worth of the new residual signals e_{c}(n).

Here, assuming the number of sampling data per pitch is L₁ and the number of data per frame is N, when iₒₚₜ+L₁/2>N, the residual signals e(0) to e(N−1) of one frame are not sufficient to form the new residual signals e_{c}(n). Data after the residual signal e(N−1) becomes necessary. In an actual audio signal precessing apparatus, since an audio signal is input in units of frames, the data of the next frame is sometimes still not ready while the audio encoded data of a first frame is being processed. In this case, the portion of the data over one frame has to be estimated from the one frame of data being processed by extrapolation etc.

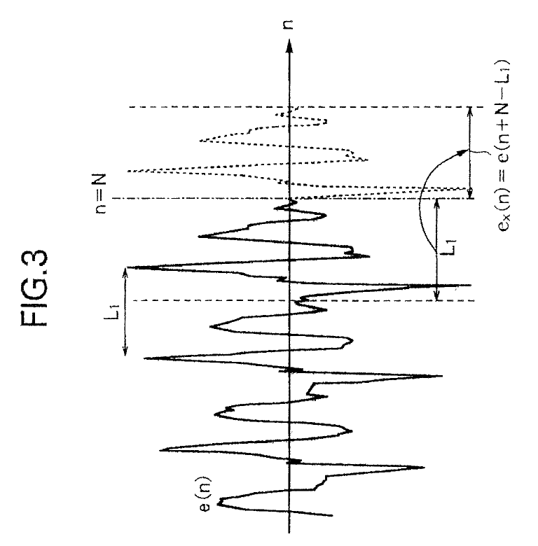

Extrapolation takes note of the fact that audio data has continuity in a certain time period. It uses one pitch worth of data going back from the tail end of one frame as an estimated value and connects this to the tail end of the frame to make up for the gap. FIG. 3 is a waveform diagram showing the processing for compensating for data in residual signals of one frame by extrapolation.

As shown in the figure, when using extrapolation, one pitch worth L₁ of data is cut out from a position reached by going backward by one pitch L₁ from the tail end (position where n=N) of one frame of data. The L₁ amount of data is added after the frame so as to fill the gap in the data. Further, in accordance with need, the cut out one pitch worth of data may be added one more time.

The string of data eₓ(n) (n≧N) compensated for by the above extrapolation can be expressed by the next equation:

Eₓ(n)=e(n+N−L₁) (3)

When a gap arises in the residual signals e(0) to e(N) of one frame, the gap in data can be filled by extrapolation and that new data used to produce new residual signals e_{c}(n).

Note that when extrapolating data, to eliminate discontinuity of data at joined portions, it is effective to apply a window function to the portion around the joined data and add that joined data.

In the above reproduction method of a residual signal e_{c}(n), to generate one pitch worth of data, the first half of the data is generated by using the first half of one pitch worth of the original residual signals, while the second half of the data is generated by using the second half of the one pitch worth of the original residual signals are used as reference signals, finding the code string closest to the reference signals from the second pitch worth of data of the original residual signals, and using the closest signals as the second half in the one pitch worth of the new residual signals. As the criteria for gauging the degree of approximation with the reference signals, the square error is calculated and the signals giving the smallest square error are found. Namely, each pitch worth of data in the new residual signals e_{c}(n) are obtained by joining data from different pitch section as their first half and second half, so discontinuity arises at the joined portions of data in some cases. If reproducing an audio signal based on residual signals e_{c}(n) by an LPC synthesis filter, the discontinuity of the residual signals can be reduced to some extent. To further eliminate the discontinuity, new residual signals e_{c}(n) are generated for the starting part of the second half of the data by applying a window function to the reference signals e_{ref}(n) and cut-out signals and adding them.

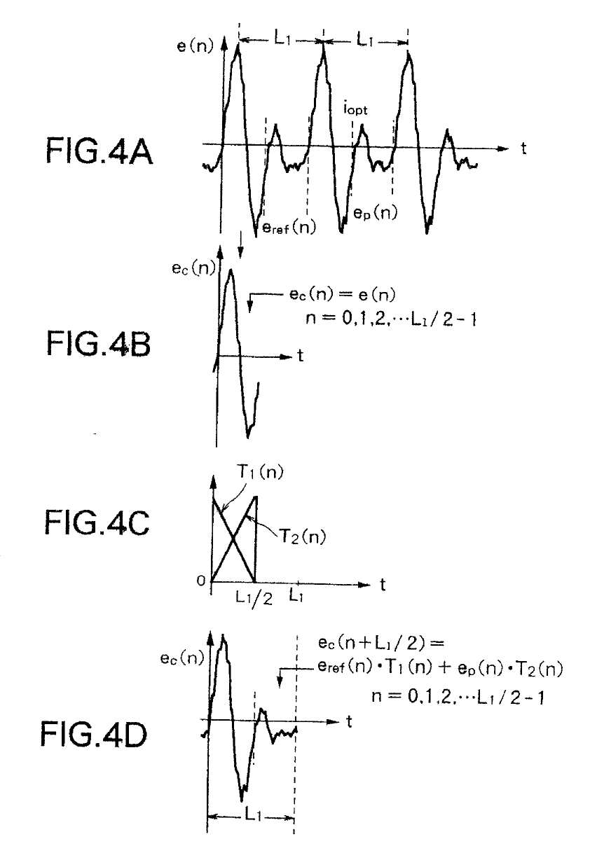

As a window function, it is possible to use the usually frequently used triangle window. FIGS. 4A to 4D are waveform diagrams of the joining of residual signal data by using a triangle window.

FIG. 4A is a waveform diagram of original residual signals e(n). FIG. 4B is a waveform diagram of new residual signals e_{c}(0) to e_{c}(L₁/2−1) formed by the codes e(0) to e(L₁/2−1) of half of one pitch cut out from the residual signals e(n). Using the second half data of that one pitch of the residual signals e(n) as reference codes e_{ref}(n), a position iₒₚₜ giving the smallest square error E(i) is calculated. Data of an amount of L₁/2 is cut out from the iₒₚₜth data in the second pitch worth of the original residual signals e(n).

As explained above, by connecting the cut-out L₁/2 amount of data after the residual signals e_{c}(0) to e_{c}(L₁/2), one pitch worth of residual signals e_{c}(n) can be generated. However, discontinuity sometimes occurs in the residual signals e_{c}(n) generated by such simple connection. To deal with this, the triangle window functions T₁(n) and T₂(n) shown in FIG. 4C are applied to the reference signals e_{ref}(n) and the cut-out signals and the results added to obtain the second half data in one pitch worth of the residual signals e_{c}(n). FIG. 4D is a waveform diagram of one pitch worth of residual signals generated by connecting first half data and second half data of one pitch by operation using the triangle window functions.

Note that processing for application of the triangle window functions can be realized by a simple multiplication operation using a variable λ in accordance with the position of the residual signals as shown in the next equation:

$${e}_{c} ( n ) = \{ \begin{matrix}( 1 - λ ) {e}_{ref} ( n ) + λ e ( {i}_{opt} + n ) \\ ( λ = n / \frac{L}{2} \cdot e ( {i}_{opt} + n ) ( L / 2 \leq n < {N}^{′} )\end{matrix} \qquad ( 4 )$$

As explained above, by applying window functions to the reference signals and the cut-out signals and adding the results to form the residual signals e_{c}(n) it is possible to improve the continuity of data at the joined portions of the residual signals e_{c}(n) generated.

In the above explanation, a signal processing method for increasing the reproduction speed of an audio signal was explained. When lowering the reproduction speed of an audio signal, in a reverse way to the above processing, it is necessary to extend the residual signals e(n) on the time axis without changing the pitch. Namely, processing is performed for increasing the amount of data of the residual signals e(n), for example, by extrapolation, while maintaining the length of the pitch.

When estimating data by extrapolation, note is taken of the continuity of an audio signal. Using as an unit the length of a pitch, one pitch worth of data is cut out each time from the tail end of one frame of data. Then, the cut-out string of data is connected after the last data in one frame. If necessary, one pitch worth of data another pitch before the first cut-out position may be cut out and connected to the tail end of the data extrapolated the first time.

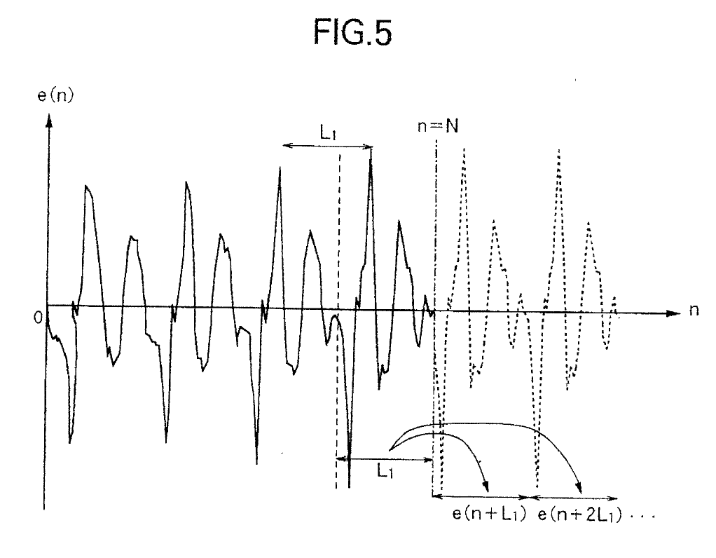

FIG. 5 is a waveform diagram of an example of extension of residual signals e(n), for example, when extending an original audio signal 1.5 fold on the time axis.

As shown in the figure, in this example, four pitches' worth of data of residual signals are fit in one frame. Namely, when setting a length of one frame as N and a length of a pitch as L₁ (N=4L₁), it is necessary to one frame of code data by two pitches' worth of data in order to extend the residual signals e(n) 1.5-fold on the time axis.

The waveform in FIG. 5 shows a method of increasing the residual signal e(n) by extrapolation. Here, the last one pitch worth of data is cut out from the four pitches' worth of data in one frame. Then, the string of cut-out data is connected twice to the tail end of the frame. As a result of the extrapolation, two pitches' worth of residual signals e(N) to e(N+2L₁−1) are further added to the N number of data e(0) to e(N−1) in one frame. Namely, new residual signals e_{c}(n) including (N+2L₁) number of data are generated for the original one frame worth of N number of data. Since the residual signals e_{c}(n) have an unchanged pitch length from the original residual signals e(n), by generating an audio signal by an LPC synthesis filter by using the converted residual signals e_{c}(n), an audio signal extended 1.5-fold on the time axis can be reproduced without changing the pitch.

Note that the extrapolation of the residual signals e(n) is not limited to the above method. For example, when extending original residual signals e(n) shown in FIG. 5 1.5-fold on the time axis, it is possible to cut out two pitches' worth of data from the tail end of the frame of the original one frame worth of residual signals and join that cut-out data to the end of the frame. As a result, residual signals e_{c}(n) extended 1.5-fold from the original signals are obtained without changing the pitch. By generating an audio signal by an LPC synthesis filter using the new residual signals e_{c}(n), an audio signal extended 1.5-fold on the time axis can be reproduced without changing the pitch.

Note that the above extension of residual signal data by extrapolation simply connects a cut-out string of data to the end of the original data, so discontinuity sometimes arises at the joined portions of data in the new residual signals e_{c}(n). If reproducing an audio signal based on residual signals e_{c}(n) by an LPC synthesis filter, the discontinuity of the residual signals can be reduced to some extent. To further eliminate the discontinuity, it is possible to apply a window function to the data of the joined portions of the residual signals and add them.

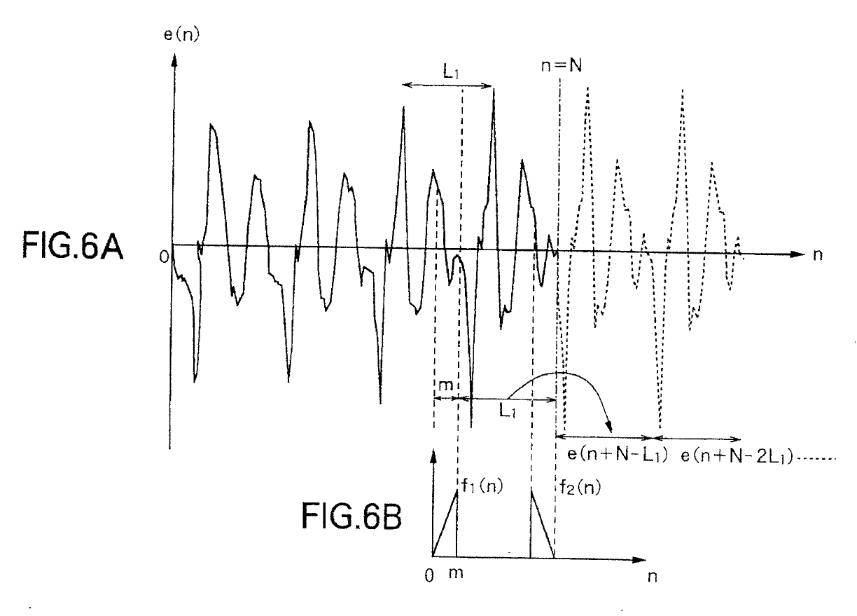

FIGS. 6A and 6B are views of processing for connection by using as a window function a triangle window function having a length of m. FIG. 6A shows an example of a waveform of the residual signals e(n). As shown in the figure, a data string longer by m (m<L₁) than the one pitch length L₁ is cut out at the time of cutting. Then, the triangle window function f₁(n) shown in FIG. 6B is applied to the m number of data at the top of the cut-out data. On the other hand, triangle function f₂(n) shown in FIG. 6B is applied to the last m number of data in the data of the original one frame of residual signals e(n). The data obtained by adding the results of application of the window functions is connected to a position m number of data before the end of the frame of the residual signals e(n). L₁ number of data continuing from the first m number of cutout data string is connected thereafter.

As explained above, one pitch worth of data can be extrapolated after the one frame worth of data. Furthermore, when connecting one pitch worth of data after the extrapolated data, it is sufficient to add data to which window functions have been applied in the same way as explained above.

As explained above, by using triangular windows to apply window function to a predetermined number of data after the top of the cut-out data and after one frame of data, adding the results, and connecting them as data of new residual signals e_{c}(n) discontinuity of data generated by simple cutout and connection can be suppressed and the continuity of an audio signal reproduced by an LPC synthesis filter based on the residual signals e_{c}(n) can be improved.

As explained above, according to the present invention, by shortening or extending residual signals on a time axis while maintaining pitch information and synthesizing an audio signal by an LPC synthesis filter based on the generated new residual signals, an audio signal compressed or expanded on the time axis can be reproduced without changing the pitch. Namely, a reproduction speed of an audio signal can be raised and lowered without changing the pitch.

Note that the above embodiment is an example where the present invention was applied to a CELP decoder. Needless to say, the processing for conversion of the reproduction speed of an audio signal of the present invention is not limited to applications using a CELP decoder. The invention may be applied to other audio signal processing apparatuses handling residual signals including pitch information of an audio signal based on the same principle.

Summarizing the effects of the invention, as explained above, according to an audio signal processing apparatus and processing method of the present invention, it is possible to freely change a reproduction speed of an audio signal without changing the pitch of the audio signal.

Furthermore, when connecting data by extrapolation etc., by applying window functions to data around the connection portions and adding the results, it is possible to reduce the discontinuity of the joined portions of the connected data, maintain the continuity of the reproduced audio signal, and improve the quality of sound.

Note that the embodiments explained above were described to facilitate the understanding of the present invention and not to limit the present invention. Accordingly, elements disclosed in the above embodiments include all design modifications and equivalents belonging to the technical field of the present invention.

What is claimed is:

1. An audio signal processing apparatus for, reproducing an audio signal by decoding encoded predictive residual signals produced by forward prediction on a frame by frame basis, the apparatus comprising:
an excitation source modifying means for extending or shortening said predictive residual signals on a time axis and
a synthesizing means for synthesizing an audio signal based on predictive residual signals converted by said excitation source modifying means.

2. An audio signal processing apparatus as set forth in claim 1, said excitation source modifying means comprising:
dividing means for dividing said predictive residual signals into a plurality of sub-frames based on a pitch;
second dividing means for dividing a signal of a sub-frames into first signal whose length is m (m is an integer and m<L, L is the length of said sub-frame) and the remaining signal whose length is (L−m) as a reference signal;
finding means for finding the closest signal of said reference signal from other sub-frame,
wherein said excitation source modifying means shortens said predictive residual signals by concatenating the first signal and the closest signal.

3. An audio signal processing apparatus as set forth in claim 2, wherein said finding means calculates cross-correlation values with said reference signal for signal of said other sub-frame, takes out signal as the closest signal from a position where the calculated cross-correlation value becomes the largest.

4. An audio signal processing apparatus as set forth in claim 2, wherein said finding means calculates a square error with said reference signal for signal of said other sub-frame, takes out signals as the closest signal from a position where the calculated square error becomes the smallest.

5. An audio signal processing apparatus as set forth in claim 1, wherein
said excitation source modifying means extends said predictive residual signals by a certain extension rate by finding a signal having a predetermined length from the end of the predictive residual signals of a frame; and
concatenating said signal after the end of the predictive residual signals to generates extended predictive residual signals.

6. An audio signal processing apparatus as set forth in claim 1, wherein said synthesizing means is a linear prediction code synthesis filter.

7. An audio signal processing apparatus for reproducing an audio signal by decoding encoded predictive residual signals produced by forward prediction on a frame by frame basis, the apparatus comprising:
an excitation source modifying means for shortening the predictive residual signals by taking out first signal from signal in a sub-frame of the predictive residual signals and second signal from signal in a following sub-frame based on cross-correlation while maintaining the pitch, or for extending the predictive residual signals by connecting data estimated by extrapolation to signals of a frame while maintaining the pitch, and
a synthesizing means for synthesizing an audio signal based on predictive residual signals converted by said excitation source modifying means.

8. An audio signal processing apparatus as set forth in claim 7, said excitation source modifying means comprising:
dividing means for dividing a signal of said sub-frame into the first signal whose length is m (m is an integer and m<L, L is the length of said sub-frame) and the remaining signal whose length is (L−m) as a reference signal;
finding means for finding the closest signal of said reference signal from the other sub-frame,
wherein said excitation source modifying means shortens said predictive residual signals by concatenating the first signal and the closest signal.

9. An audio signal processing apparatus as set forth in claim 8, wherein
said excitation source modifying means comprises:
a first multiplying means for multiplying said reference signal by a first window function;
a second multiplying means for multiplying signal taken out from said other sub-frame by a second window function; and
an adding means for adding results of said first and second multiplying means; and
wherein said excitation source modifying means concatenates the results of said adding means after the first signal taken out from said sub-frame to generate one pitch worth of new predictive residual signals.

10. An audio signal processing apparatus as set forth in claim 8, wherein said finding means calculates cross-correlation values with said reference signal for signal of said other sub-frame, takes out signal as the closest signal from a position where the calculated cross-correlation value becomes the largest.

11. An audio signal processing apparatus as set forth in claim 8, wherein said finding means calculates a square error with said reference signal for signal of said other sub-frame, takes out signal as the closest signal from a position where the calculated square error becomes the smallest.

12. An audio signal processing apparatus as set forth in claim 7, wherein said excitation source modifying means extends said predictive residual signals by a certain extension rate by finding a signal having a predetermined length from the end of the predictive residual signals of a frame; and concatenating said signal after the end of the prediction residual signals to generates extended predictive residual signals.

13. An audio signal processing apparatus as set forth in claim 7, wherein said synthesizing means is a linear prediction code synthesis filter.

14. An audio signal processing method for extending or shortening predictive residual signals on a time axis in decoding of a signal encoded by forward prediction on a frame by frame basis, comprising:
processing for shortening the predictive residual signals by taking out first signal from signal in a sub-frame of the predictive residual signals and second signal from signal in a following sub-frame based on cross-correlation while maintaining the pitch or for extending the previous residual signals by connecting data estimated by extrapolation to signals of a frame while maintaining the pitch so as to shorten or extend the signals of one frame, and
processing for synthesizing an audio signal based on such shortened or extended predictive residual signals.

15. An audio signal processing method as set forth in claim 14, further comprising shortening said predictive residual signals by
dividing a signal of said sub-frame into the first signal whose length is m (m is an integer and m<L, L is the length of said sub-frame) and the remaining signal whose length is (L−m) as a reference signal;
finding the closest signal of said reference signal from the other sub-frame; and
concatenating the first signal and the closest signal.

16. An audio signal processing method as set forth in claim 15, further comprising shortening said predictive residual signals by
first multiplication processing for multiplying said reference signal by a first window function;
second multiplication processing for multiplying signal taken out from said other sub-frame by a second window function; and
adding processing for adding results of said first and second multiplying means and
concatenating the results of said adding processing after the first signal taken out from said sub-frame to generate one pitch worth of new predictive residual signals.

17. An audio signal processing method as set forth in claim 14, further comprising extending said predictive residual signals by a certain extension rate by finding a signal having a predetermined length from the end of the predictive residual signals of a frame; and concatenating said signal the end of the predictive residual signals to generates extended predictive residual signals.
